(19) United States
(12) Patent Application Publication
(10) Pub. No.: US 2007/0165573 A1
(43) Pub. Date: Jul. 19, 2007

(54) Mobility Management with Controlled Use of New Reject Causes

(76) Inventor: Hannu Hietalahti, Kiviniemi (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/458,168

(22) Filed: Jul. 18, 2006

(30) Foreign Application Priority Data
Jan. 19, 2006 (EP) 06 001 138.4

(51) Int. Cl. H04Q 7/20

(52) U.S. Cl. 370/331; 455/436

(57) ABSTRACT

Due to possibly different standard versions implemented in a mobile station (MS) and a network, the MS may not be able to interpret all reject-cause values used by the network. In this case, a MS may receive upon a mobility-management (MM) request a reject message with an unknown reject-cause value and re-transmit its MM request. According to one aspect of the invention, a MM method for a mobile station in a public land mobile network, hereinafter network, is provided. The method comprises the steps of ascertaining on the network side whether the request is to be rejected, if the mobility-management request is to be rejected, ascertaining on the network side a suitable first reject-cause information element indicating the reason for rejection, and ascertaining whether the first reject-cause value is known to the mobile station, if the reject-cause value is not known to the mobile station, sending to the mobile station a mobility-management response suitable to prevent a re-transmission of the mobility-management request by the mobile station.

### FIELD OF THE INVENTION

The present invention relates to digital cellular telecommunication. In particular, it relates to mobility management in a digital cellular telecommunication system. Specifically, the present invention relates to a mobility-management method related to a mobile station in a public land mobile network, to a mobility-management unit for a network node of a public land mobile network, to a software module for implementation of a mobility-management unit in a network node of a public land mobile network, to a network node for operation in a public land mobile network, and to a public land mobile network.

### BACKGROUND OF THE INVENTION

One of the most widely used digital wireless telecommunications standards is the Global System for Mobile communications (GSM) standard. The GSM standard is incorporated herein by reference.

A GSM-compliant wireless communication system includes a radio access network, known as a base station subsystem (BSS). The BSS comprises a plurality of base transceiver stations (BTSs) for transmitting and receiving radio frequency (RF) signals from a subscriber's mobile station (MS). Examples of mobile stations are cellular phones, or handheld and portable computers with radio module. The BSS further has at least one base station controller (BSC) for managing radio resource and routing signals to and from the BTSs. Each BTS is constructed to transmit and receive signals from within a predetermined geographic region called a cell.

In accordance with the GSM standard, the system further includes a core network having a circuit-switched portion and a packet switched portion. The circuit switched portion includes a mobile-services switching center (MSC) that switches telephone calls between the radio-access network and a public switched telephone network (PSTN) or a public land mobile network (PLMN). The MSC is connected to a BSC through a standard interface known as the A-interface that requires signaling messages between the BSC and the MSC to be arranged in a particular order and format. The packet-switched portion, also known as General Packet Radio Service (GPRS), includes a Serving GPRS Support Node (SGSN), similar to the MSC of the voice portion of the system, for serving and tracking the MS, and a Gateway GPRS Support Node (GGSN) for establishing connections between packet-switched networks and a mobile station. Both the SGSN and the MSC may also contain subscriber data useful for establishing and handing over call connections. The core network also includes a home location register (HLR) for maintaining “permanent” subscriber data and a visitor location register (VLR) (and/or a SGSN) for temporarily maintaining subscriber data retrieved from the HLR and up-to-date information on the location of the mobile station.

Mobility management (MM) is performed for GPRS services and for non-GPRS services. MM forms a sub-layer of the layer 3 of the signaling protocol architecture of the GSM standard. Beside MM, radio resource (RR) management and connection management (CM) form further sub-layers of layer 3. The main function of the MM sub-layer is to support the mobility of a mobile station, such as informing the network of its present location and providing user identity confidentiality. A further function of the mobility management (MM) sub-layer is to provide connection management services to different entities of the connection management (CM) sub-layer. MM procedures performed within the framework of GPRS services will also be referred to as GMM procedures herein, if they differ from MM procedures for non-GPRS services.

The MM sub-layer is also present in published recent and upcoming mobile telecommunication standards of the 3^{rd} Generation Partnership Project (3GPP). MM procedures are disclosed in the technical specification 3GPP TS 24.008 V5.12.0 of June 2004, available for instance through the URL ftp://ftp.3gpp.org/Specs, and hereinafter referred to as TS24.008.

TS24.008 defines GMM and MM procedures. The present invention deals with mobility-management requests initiated by a mobile station. The following MM and GMM procedures can be initiated by a mobile station:
IMSI Attach (MM)
IMSI Detach (MM)
Location Update (MM)
Periodic Location Update (MM)
GPRS Attach and combined GPRS Attach (GMM)
GPRS Detach and combined GPRS Detach (GMM)
Normal Routing Area Update and combined Routing Area Update (GMM)
Periodic Routing Area Update (GMM).

During MM and GMM procedures the corresponding public land mobile network (PLMN) checks the subscription status of the user of the particular mobile station. In case the mobile station is currently not located in the coverage of its home PLMN (HPLMN) but in a visited PLMN (VPLMN), the VPLMN will additionally check a roaming agreement with the HPLMN operator. If an Attach Request is accepted by the network an “Attach-Accept” message is sent to the mobile station (MS). Similarly, “Location-Update-Accept” or “Routing-Area-Update-Accept” messages are returned to the MS after successful Location-Update and Routing-Area-Update procedures, respectively.

On the other hand, the network will return a complete or partial “Reject” message to the MS if some problem is met. For instance, if the international mobile subscriber identity (IMSI) value associated with the MS is unknown in either the HLR of the HPLMN or in the VLR of the VPLMN, “Attach”, “Location-Update” or “Routing-Area-Update” requests issued by the MS will be rejected by the selected PLMN with a suitable “Reject” message. The rejection may also be related to subscription options. For instance, if a MS is, by subscription, not allowed to operate in a location area, the corresponding PLMN will reject a “Location-Update” request of the MS in that location area. Other reasons for rejection may be related to congestion in the particular PLMN.

The “Reject” message contains a reject cause value identifying the reason of rejection. A larger number of reject causes is defined in 3GPP TS 24.008. TS24.008 also specifies the behavior of the MS after reception of a defined reject cause value from the network.

However, due to possibly different standard versions implemented in the MS and the network, the MS may not be able to interpret all reject cause values used by the network. In this case, a MS may receive a “Reject” message with an unknown reject cause value. This is typically the case when a later version of the network is serving an older version of the mobile, and new reject cause values have been added to the later version of specification.

TS24.008 specifies the further proceeding on the side of the MS in this situation. The MS starts a timer-controlled re-transmission cycle of its corresponding request to the network. The number of re-transmission attempts is limited and controlled with the aid of an attempt counter.

In this situation it is clear from the beginning that the MS will not receive the requested service. The network responds to every re-transmitted request with the same reject cause value. The re-transmission attempts can take up to minutes, before the attempt counter reaches the preset maximum value. Thus, radio resources are wasted for re-transmitted request messages, which are bound to fail, and the corresponding response messages.

Change request 24.008 CR852, revision 3, version 6.5.0, Tdoc N1-041602, dated Oct. 8, 2004, hereinafter 24.008 CR852, proposes to immediately set the attempt counter to its maximum value after receiving registration reject messages with one of the causes “semantically incorrect message”, “invalid mandatory information message”, “message type not existent”, “information element not existent”, or “protocol error unspecified”. This solution is based on the recognition that these reasons for rejection are probably caused by an implementation problem rather then a temporary network problem. This way, registration attempts are immediately stopped. An optional PLMN reselection on the side of the MS is suggested in order to find an alternative PLMN to obtain service from.

However, a disadvantage of the solution of 24.008 CR852 is that its effect is only noticeable after an implementation into a large number of existing “legacy” mobile stations using older signaling protocol versions, in order to give rise to a considerable decrease in useless signaling activity.

### SUMMARY OF THE INVENTION

It is therefore an object of the invention to provide a mobility-management method for a mobile station in a public land mobile network, which allows achieving a noticeable decrease of useless MM signaling activity with small implementation cost.

It is a further object of the invention to provide a mobility-management unit for a network node of a public land mobile network, which allows achieving a noticeable decrease of useless MM signaling activity with small implementation cost.

It is a further object of the invention to provide a software module for implementation of a mobility-management unit in a network node of a public land mobile network, which allows to achieve a noticeable decrease of useless MM signaling activity with small implementation cost.

Finally, it is an object of the present invention to provide a public land mobile network, which allows achieving a noticeable decrease of useless MM signaling activity with small implementation cost. According to a first aspect of the invention, a mobility-management method for a mobile station in a public land mobile network, hereinafter network, is provided. The method comprises the steps of
ascertaining on the network side whether the request is to be rejected,
if the mobility-management request is to be rejected, ascertaining on the network side a suitable first reject-cause information element indicating the reason for rejection, and ascertaining whether the first reject-cause information element is known to the mobile station,
if the reject-cause information element is not known to the mobile station, sending to the mobile station a mobility-management response suitable to prevent a retransmission of the mobility-management request by the mobile station.

The method of the first aspect of the present invention solves the problems set forth above by modifying the mobility-management procedures on the network side. According to the method of the invention, it is not the mobile station but the network, which takes steps to avoid useless mobility-management signaling. After ascertaining a suitable first reject-cause information element, which indicates the actual reason for rejecting the mobility-management request of the mobile station, the network side ascertains whether this first reject-cause information element is known to mobile station. This step is performed before sending out a mobility management response to the mobile station.

If the first reject-cause information element is found to be unknown to the mobile station, a mobility-management response is sent to the mobile station, which is suitable to prevent a pre-transmission of the MM request by the mobile station. This way, a re-transmission of the MM request is avoided without having to implement additional functionality in the MS.

In the following, preferred embodiments of the method of the invention will be described.

According to a preferred embodiment, the step of ascertaining whether the reject cause information element is known to the mobile station comprises ascertaining information about signaling-protocol compliance between the mobile station and the public land mobile network.

The present embodiment makes use of the fact that information on whether the mobile station knows a particular first reject-cause information element is implicitly contained in information about signaling protocol compliance, i.e., a comparison of signaling protocols used in MM signaling on the side of MS and on the network side.

A look-up table can for instance be used to allocate reject-cause information elements to signaling protocols. This way, it can easily be ascertained on the network side whether a particular signaling protocol used by the MS supports a reject-cause information element describing the actual reason for rejecting the MM request under consideration.

Signaling-protocol compliance is in different embodiments ascertained on the basis of different information. The information obtained by the different embodiments described next below can be combined to increase the probability of a correct assessment of signaling-protocol compliance.

In a first alternative, ascertaining information about signaling-protocol compliance comprises ascertaining, which signaling protocol the mobile station used for the mobility-management request under consideration. For instance, the MS may use a signaling protocol according to the UMTS terrestrial radio access network standard, a wireless local area network (WLAN) protocol according to a IEEE 802.11 standard, or an internet protocol (IP) multimedia subsystem standard (IMS), as example cases. In another alternative embodiment, ascertaining information about signaling-protocol compliance comprises ascertaining whether the mobile station supports a specific signaling-protocol release. The signaling-protocol release refers to a particular version of a standard. For instance, the 3GPP standard has been under continuous development. A 3GPP standard release is a set of standards supporting certain functionalities defined on the particular release level.

According to a further embodiment ascertaining information about signaling-protocol compliance comprises extracting information contained in at least one Mobile-Station-Classmark information element received from the mobile station.

The purpose of Mobile-Station-Classmark information elements is to provide the network with information concerning aspects of the mobile station equipment. At least three Mobile-Station-Classmarks are being used in the 3GPP release 6. The Mobile-Station-Classmark 1 information element provides the network with information concerning aspects of high priority. The information affects the manner, in which the network handles the operation of the mobile station. The Mobile-Station-Classmark information is independent of the frequency band of the channel it is sent on. Information contained in the Mobile-Station-Classmark 1 information element comprises the revision level (such as GSM phase 1 or 2), the radio frequency (RF) power capability and use of certain transmission option and algorithm support. The Mobile-Station-Classmark 2 information element provides the network with information concerning aspects of high and low priority of the mobile station equipment. The information contained in this information element also affects the manner, in which the network handles the operation of the mobile station. Information comprised by the Mobile-Station-Classmark 2 information element comprises the revision level, the support of encryption algorithms, the capability of packet switching, the support of the short message service (SMS) and other features. The purpose of the Mobile-Station-Classmark 3 information element is to provide the network with information concerning aspects of the mobile station, which might affect the manner, in which the network handles the operation of the mobile station. Information contained in the Mobile-Station-Classmark 3 information element comprises the support of certain GSM bands (P-GSM, E-GSM, R-GSM, GSM1800), the support of specific encryption algorithms, switch-measure information, supported positioning methods, modulation capability etc.

Note that generally a network can distinguish the difference between, for example, GSM phase 2 and UMTS R99 and later. However, the difference between GSM R97 and GSM R98 or R99, Rel-4, 5, 6, etc. can only be deduced indirectly from the indicated support of certain features within certain releases and thus it is not always directly distinguishable at present. So the re-mapping of reject cause values according to the invention works on reject cause values that were added at the same time when a new revision or some other version information telling the version level was introduced.

Preferably, ascertaining information about signaling-protocol complying comprises in this embodiment evaluating information about the signaling-protocol revision level contained in the at least one Mobile-Station-Classmark information element received from the mobile station. According to a further alternative embodiment, ascertaining information about signaling-protocol compliance comprises evaluating information about a revision level contained in at least one Radio-Access-Capability information element received from the mobile station.

The purpose of the Radio-Access Capability (RAC) information element is to provide the radio part of the network within information concerning radio aspects of the mobile station. Information comprised by the RAC IE comprises the access technology type and supported frequency bands (GSMP, E, R or 1800) and other information, which might also be contained in Mobile-Station-Classmark information elements.

In a further embodiment of the method of the invention, the step of ascertaining whether the mobile station knows the reject-cause information element comprises ascertaining whether the mobile station supports a specific signaling-protocol feature.

(In one embodiment, this implies deducing a base release of a mobile station from the “latest” supported feature it indicates.

Another embodiment comprises adding a capability bit to the RAC IE to indicate support of new (G)MM cause values in the same release where those cause values are added. In this embodiment, the network would get an explicit indication of the support.

According to a further embodiment of the method of the invention, the step of sending a mobility-management response comprises sending a mobility-management response message that contains control information triggering the mobile station to select a different public land mobile network for service. This way, the mobile station will not retransmit its MM request with the current PLMN, but search for a different PLMN, to obtain service from.

In one embodiment, specific messages or reject-cause values that will instruct the MS to select a different PLMN include messages from the network that indicate that access to the requested PLMN is not allowed, or that roaming is not allowed in the present location area of the MS. For specific examples of such messages, see for instance TS24.008, sub-clause 4.4.4.7 and 4.7.5.2.4, # 11 (PLMN not allowed), and # 13 (Roaming not allowed in this location area).

A further embodiment comprises a step of ascertaining on the network-side an alternative public land mobile network, and wherein the step of sending to the mobile station a mobility-management response comprises instructing the mobile station to request service from the alternative public land mobile network.

In a further embodiment, the step of sending a mobility-management response comprises sending a mobility-management response message that contains control information triggering the mobile station to abandon the mobility-management request without selecting a different public land mobile network for service.

In one embodiment, specific messages or reject-cause values that will instruct the MS to abandon its request but stay in the current PLMN include messages from the network indicating that access to a current location area is not allowed, or that no suitable cells are present in a current location area. For specific examples of such messages, see for instance TS 24.008 sub-clause 4.4.4.7 (LU), # 12 (Location Area not allowed) or # 15 (No Suitable Cells In Location Area. For GPRS services the same cause values apply, but TS24.008, sub-clause 4.7.5.2.4 additionally lists # 7 (GPRS services not allowed), # 9 (MS identity cannot be derived by the network), and # 10 (Implicitly detached).

In a further embodiment, the step of sending a mobility-management response comprises sending a mobility-management response message containing a second reject-cause information element, which is different from the first reject-cause element and known to the mobile station. This embodiment, which can particularly be combined with one of the two previous embodiments, will trigger a foreseeable desired behavior of the MS. However, the reject-cause information element might not reflect the actual reason for rejection.

According to a second aspect of the invention, a mobility-management unit for a network node of a public land mobile network is provided. The mobility-management unit is configured to process MM requests received from a mobile station and comprises a rejection-management unit, which is configured to process mobility-management requests received from a mobile station, and comprising a rejection-management unit, which is configured to
ascertain whether a received mobility-management request is to be rejected,
if the mobility-management request is to be rejected, ascertain a suitable first reject-cause information element indicating the reason for rejection,
ascertain whether the first reject-cause information element is known to the mobile station,
if the reject-cause information element is not known to the mobile station, generate a mobility-management response to be sent to the mobile station and suitable to prevent a re-transmission of the mobility-management request by the mobile station.

The mobility-management unit (hereinafter also MM unit) of the second aspect of the invention forms a functional unit comprised by a network node such as a MSC or SGSN. It implements the method of the first aspect of the invention, which was set forth above. The advantages of the MM unit of the present aspect of the invention thus correspond to those of the MM method of first aspect of the invention.

In the following, preferred embodiments of the MM unit will be described.

In a first embodiment, the rejection-management unit of the MM unit comprises a protocol-analysis unit, which is configured to ascertain information about, and provide at its output a protocol-compliance signal indicative of signaling-protocol compliance between the mobile station and the public land mobile network. The protocol-compliance signal can in a simple embodiment be a binary information element stating whether the MS signaling protocol is compliant with that of the network or not. In a preferred embodiment, the protocol compliance signal provides further information on the protocol or protocol release or protocol release revision level used by the MS.

Therefore, in a further embodiment of the MM unit, the protocol-analysis unit is configured to ascertain, which signaling protocol the mobile station used to provide the received mobility-management request. In a further embodiment, the protocol-analysis unit is configured to ascertain whether the mobile station supports a specific signaling-protocol release.

In a further embodiment, the protocol analysis-protocol unit is configured to extract information contained in at least one Mobile-Station-Classmark information element received from the mobile station. As explained above at full length in the context of the corresponding embodiment of the method of the invention the Mobile-Station-Classmark information elements provide a wealth of information regarding the signaling protocol used by the MS. The information is provided in a predetermined order as described by TS24.008. Therefore, the protocol-analysis unit can easily extract certain bit position within a Mobile-Station-Classmark IE to obtain the desired information.

Therefore, in a particular embodiment, the protocol-analysis unit is configured to evaluate information about a signaling-protocol revision level contained in the at least one Mobile-Station-Classmark information element.

In an alternative embodiment, the protocol-analysis is configured to evaluate information about a revision level contained in at least one Radio-Access-Capability information element received from the mobile station.

In a further embodiment the protocol-analysis unit is configured to ascertain whether the mobile station supports a specific signaling-protocol feature.

Preferably, the rejection-management unit comprises a comprises a rejection controller, which is connected with the protocol-analysis unit and configured to select a rejecting mobility-management response message in dependence on the protocol-compliance signal and provide at its output a rejection-control signal indicative of the selected rejecting mobility-management response messages to be sent to the mobile station. The rejection controller uses the input of the protocol-analysis unit to select a suitable response message in dependence on the protocol compliance signal. The selection is indicated by a rejection-control signal, which is provided at the output of the rejection controller. The structure of this embodiment is particularly suited for a functional add-on to an existing MM unit. The protocol-analysis unit and the rejection controller can be used in connection with existing mobility management algorithms on the network side. The add-on needs to operate only in case the mobility-management unit determines that a current MM request of a MS is to be rejected. This information, combined with the suitable first reject-cause information element indicating the reason for rejection, is forwarded to the protocol-analysis unit of the rejection management unit. The rejection controller provides instructions as to a suitable MM response.

Preferably, the rejection controller is configured to select a rejecting mobility-management response message that contains control information triggering the mobile station to select a different public land mobile network for service.

In a further embodiment, the mobility management unit comprises roaming controller, which is configured to ascertain an alternative public land mobile network in dependence on the first reject cause information element, and to select a rejecting mobility-management response message that contains control information instructing the mobile station to request service from the alternative public land mobile network.

In a further embodiment, the rejection controller is configured to select a mobility-management response message that contains control information triggering the mobile station to abandon the mobility-management request without selecting a different public land mobile network for service.

In another embodiment, the rejection controller is configured to select a mobility-management response message containing a second reject-cause information element, which is different from the first reject-cause element and known to the mobile station.

According to a third aspect of the invention, a software module for implementation of a mobility-management unit in a network node of a PLMN is provided, comprising a rejection-management sub-module, which is configured to
ascertain whether a received mobility-management request is to be rejected,
if the mobility-management request is to be rejected, ascertain a suitable first reject-cause information element indicating the reason for rejection,
ascertain whether the first reject-cause information element is known to the mobile station,
if the reject-cause information element is not known to the mobile station, generate a mobility-management response to be sent to the mobile station and suitable to prevent a re-transmission of the mobility-management request by the mobile station.

The software module of the third aspect of the invention serves to implement the method of the first aspect of the invention. It can be used to update existing MM units in network nodes with the solution of the present invention.

Preferred embodiments of the software module of the third aspect of the invention are configured to implement a rejection-management unit as set forth in the context of the description of the preferred embodiment of the mobility-management unit of the second aspect of the invention.

According the a fourth aspect of the invention, a network node for operation in a public land mobile network is provided, which comprises a mobility-management unit according to the second aspects of the invention or one of its embodiments.

The network node is configured to operate as a Mobile Switching Center (MSC) or as a Serving GPRS Support Node.

According to a fifth aspect of the invention, a public mobile network is provided, which comprises a network node according to the fourth aspect of the invention or one of its embodiments.

### BRIEF DESCRIPTION OF THE DRAWINGS

FIG. 1 shows a flow diagram of a preferred embodiment of the method of the invention.

FIG. 2 shows a block diagram of a mobility-management unit according to the invention.

### DETAILED DESCRIPTION OF THE INVENTION

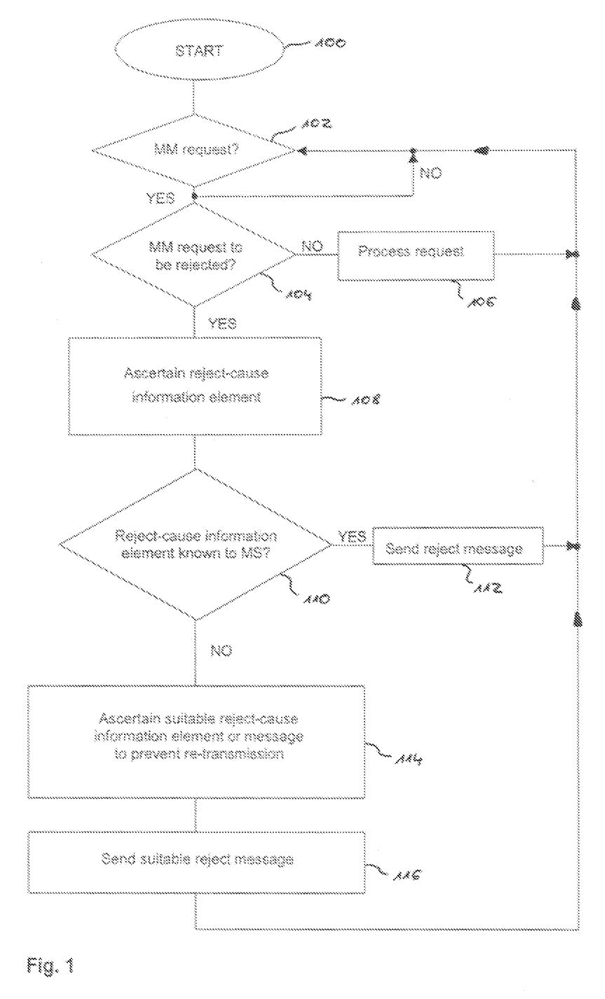

FIG. 1 shows a flow diagram of a preferred embodiment of the method of the invention. The flow diagram represents the processing flow of the mobility management unit of a network node in a PLMN in the management of a mobility-management request received from a mobile station.

The procedure is started at a step 100. At step 102 the MM unit monitors its input for an incoming MM request. Monitoring continues until a MM request has been received.

After reception of a MM request the MM unit determines whether the request can be accepted or is to be rejected (step 104). If the received MM request is to be accepted the MM unit proceeds with processing the request according to known mobility-management methods at step 106. Part of the processing is formed by sending a MM accept message back to the requesting MS. After that, the MM unit branches back to step 102 and continues monitoring its input for a new MM request.

If however, the MM unit determines at step 104 that the received MM request is to be rejected, it ascertains a reject-cause information element at step 108. The procedure up to this point is well known in the art and described in TS24.008.

At step 110, the MM unit ascertains whether the reject-cause information element is known to the MS. The reject-cause information element ascertained is referred to as the “first reject-cause information element” in the claims.

There are several alternative ways to ascertain whether the reject-cause information element is known to the MS. In one embodiment, the MM unit uses information elements contained in the MM request received from the MS. As is well known, layer 3 protocols defined in TS24.008 describe a standard format for MM messages exchanged between a MS and the network. A message contains a protocol discriminator, a transaction identifier, a message type identifier and other information elements as required. The protocol discriminator cannot be used for the purposes of ascertaining protocol compliance between the MS and the network. For the protocol discriminator, according to 3GPP TS24.007 V6.4.0, published by the 3GPP organization in March 2005, only identifies the L3 protocol, to which the message belongs. The protocol discriminator will identify the incoming message from the MS as a MM message by proper setting of the protocol discriminator value. The protocol discriminator value, however, allows distinguishing between MM messages and GMM messages.

Among the information elements commonly contained in a MM request received from a MS is a Mobile-Station-Classmark 1 information element, which provides information concerning aspects of high priority of the MS equipment. The Mobile-Station-Classmark 1 information element contains information about the revision level supported by the MS. This information forms one way of ascertaining whether the reject-cause information element is known to the MS. The evolution of signaling protocol revision levels has brought an ever-increasing number of defined reject-cause information elements, which can be used in the exchange of MM messages between the MS and the network. A table listing reject-cause information elements for each revision level preceding and including the current revision level supported by the network enables the MM unit to determine whether the reject-cause information element under consideration is supported by the revision level of the signaling protocol used by the MS.

The revision level is also contained in the Mobile-Station-Classmark 2 and 3 information elements.

Other information contained in the Mobile-Station-Classmark 1 to 3 information elements can also be used for ascertaining signaling-protocol compliance between the MS and the network. For instance, the Mobile-Station-Classmark 2 information element contains information about supported encryption algorithms. These encryption algorithms were introduced with the GSM standard by the A5/1 algorithm.

A MS not supporting GSM indicates that the encryption algorithm A5/1 is not available by properly setting a predefined bit position of a predefined octet of the Mobile-Station-Classmark 2 information element. A MS supporting GSM further specifies whether later encryption algorithm versions A5/2 and A5/3 are supported. This information can again be correlated to the support of certain reject-cause information elements by the MS, using a suitable table or any other method of correlating the support of encryption algorithms and reject-cause information elements with each other.

If, at step 110, the MM unit determines that the reject-cause information element is in fact known to the MS, it will trigger the transmission of the MM reject message containing the proper reject-cause information element to the MS (step 112).

If however, the MM unit determines at step 110 that the reject cause information element is not known to the MS, it proceeds at step 114 to ascertain a suitable cause information element or a suitable reject message to prevent a retransmission of the MM request by the MS.

Note that at this step, certain value ranges, bit patterns with wildcards, or other mechanisms may be used to indicate to the non-supporting legacy MS whether the reject cause information element unknown to the MS means to “go away”, i.e., request service from another network, or “stay put and try again, meanwhile using partial service only” in the present network.

After having ascertained the suitable reject-cause information element or message, this message is transmitted to the MS, which will then abort all further attempts to send the MM request (step 116). After this step, the MM unit returns to monitoring its input (step 102).

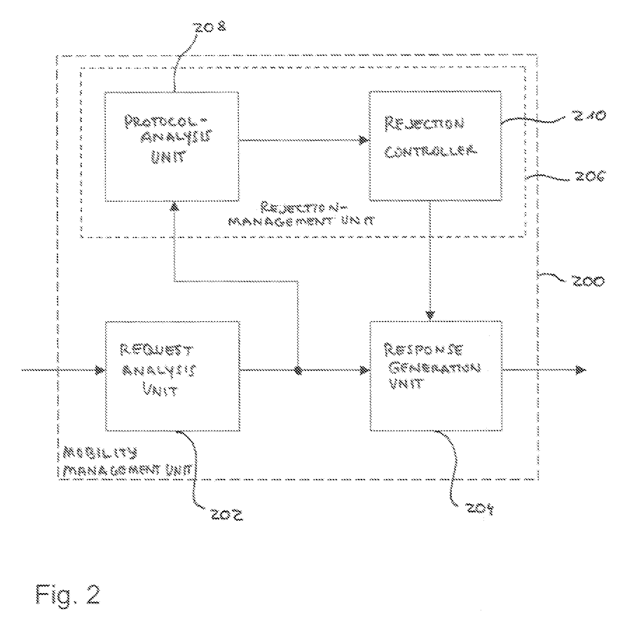

FIG. 2 shows a block diagram of a mobility-management unit according to a preferred embodiment of the invention. The mobility-management unit 200 of FIG. 2 implements the embodiment of the MM procedure shown in FIG. 1. MM unit 200 has a request analysis unit 202, which is configured to receive incoming MM requests after proper demodulation and decoding in a connected receiver unit (not shown). Request analysis unit determines the type of MM or GMM request. The message type is defined by a message type information element as defined in 3GPP TS24.007 and TS24.008, section 10.4. Depending on the received message type, request analysis unit 202 performs type-specific request processing to ascertain whether the request is to be accepted or rejected.

In case a request is to be rejected, request analysis unit 202 ascertains the proper reject-cause information element. The information on acceptance or rejection is forwarded together with the ascertained reject-cause information element to response generation unit 204. Response generation unit 204 generates a suitable MM accept message in case request analysis unit 202 has determined that the MM request is to be accepted. In case request analysis unit 202 has determined that the MM is to be rejected response-generation unit 204 waits for further control information to be received from rejection-management unit 206.

Rejection management unit 206 comprises a protocol-analysis unit 208, which is configured to ascertain information about signaling-protocol compliance between the MS and the PLMN, to which the network node containing MM unit 200 belongs. The algorithm performed by protocol-analysis unit has been described with reference to FIG. 1, step 110. Protocol analysis unit uses the information provided by request analysis unit 202 to response generation unit 204. Protocol-analysis unit 208 provides an output signal to a rejection controller 210 which is also part of the rejection-management unit. Depending on the information contained in the output signal of protocol-analysis unit 208, the rejection controller 210 determines which reject cause information element or reject message is suitable to prevent the MS providing the currently processed MM request from retransmitting its request. In the case that the requesting MS does not know the reject-cause information element, rejection controller selects a reject-cause information element known by the MS and suitable for preventing re-transmission of the MM request. If, however, protocol-analysis unit 208 finds that the signaling protocol used by the MS and the PLMN comply with each other, rejection controller 210 triggers response generation unit 204 to generate and output a MM reject message using the reject-cause information element originally provided by request analysis unit 202.

The previous description shows that the present invention advantageously avoids useless mobility-management signaling between a network and a MS that may occur if different standard versions are implemented in the MS and the network. thus achieving a noticeable decrease of such useless MM signaling activity with small implementation cost.

Variations of the described solution are possible. For instance, the handling of unknown error cause values in the MS can be improved. The MS can for instance be forced to make a PLMN selection if it receives an unknown cause value. In an improved solution, the MS can be required to check properties of the received error cause value and even if it cannot decode the unknown value precisely, it will be able to decide whether to stay in the selected PLMN or attempt to select another one. As an example, one such criterion for decision could be a cause value range, where certain cause values force a PLMN selection while others keep the MS in the selected PLMN.

1. A mobility-management method related to a mobile station in a public land mobile network, comprising the steps of:
receiving a mobility-management request in a transmission from the mobile station to the network,
ascertaining in the network whether the request is to be rejected,
if the mobility-management request is to be rejected, ascertaining in the network a suitable first reject-cause information element indicating a reason for rejection, and ascertaining whether the first reject-cause information element is known to the mobile station,
if the reject-cause information element is not known to the mobile station, sending to the mobile station a mobility-management response suitable to prevent a re-transmission of the mobility-management request by the mobile station.

2. The method of claim 1, wherein the step of ascertaining whether the reject cause information element is known to the mobile station comprises ascertaining information about signaling-protocol compliance between the mobile station and the public land mobile network.

3. The method of claim 2, wherein ascertaining information about signaling-protocol compliance comprises ascertaining, which signaling protocol the mobile station used for the mobility-management request.

4. The method of claim 2, wherein ascertaining information about protocol-protocol compliance comprises ascertaining whether the mobile station supports a specific protocol-protocol release.

5. The method of claim 2, wherein ascertaining information about signaling-protocol compliance comprises extracting information contained in at least one Mobile-Station-Classmark information element received from the mobile station.

6. The method of claim 4, wherein ascertaining information about protocol-protocol compliance comprises evaluating information about a protocol-protocol revision level contained in at least one Mobile-Station-Classmark information element received from the mobile station.

7. The method of claim 2, wherein ascertaining information about signaling-protocol compliance comprises evaluating information about a revision level contained in at least one Radio-Access-Capability information element received from the mobile station.

8. The method of claim 2, wherein the step of ascertaining whether the reject cause information element is known to the mobile station comprises ascertaining whether the mobile station supports a specific signaling-protocol feature.

9. The method of claim 1, wherein the step of sending a mobility-management response comprises sending a mobility-management response message that contains control information triggering the mobile station to select a different public land mobile network for service.

10. The method of claim 1, further comprising a step of ascertaining on the network-side an alternative public land mobile network, and wherein the step of sending to the mobile station a mobility-management response comprises instructing the mobile station to request service from the alternative public land mobile network.

11. The method of claim 1, wherein the step of sending a mobility-management response comprises sending a mobility-management response message that contains control information triggering the mobile station to abandon the mobility-management request without selecting a different public land mobile network for service.

12. The method of claim 1, wherein the step of sending a mobility-management response comprises sending a mobility-management response message containing a second reject-cause information element, which is different from the first reject-cause element and known to the mobile station.

13. A mobility-management unit for a network node of a public land mobile network, the mobility-management unit being configured to process mobility-management requests received from a mobile station, and comprising a rejection-management unit, which is configured to
ascertain whether a received mobility-management request is to be rejected,
if the mobility-management request is to be rejected, ascertain a suitable first reject-cause information element indicating the reason for rejection,
ascertain whether the first reject-cause information element is known to the mobile station,
if the reject-cause information element is not known to the mobile station, generate a mobility-management response to be sent to the mobile station and suitable to prevent a re-transmission of the mobility-management request by the mobile station.

14. The mobility-management unit of claim 13, wherein the rejection-management unit comprises a protocol-analysis unit, which is configured to ascertain information about, and provide at its output a protocol-compliance signal indicative of signaling-protocol compliance between the mobile station and the public land mobile network.

15. The mobility-management unit of claim 14, wherein the protocol-analysis unit is configured to ascertain, which signaling protocol the mobile station used to provide the received mobility-management request.

16. The mobility-management unit of claim 14, wherein the protocol-analysis unit is configured to ascertain whether the mobile station supports a specific signaling-protocol release.

17. The mobility-management unit of claim 14, wherein the protocol-analysis unit is configured to extract information contained in at least one Mobile-Station-Classmark information element received from the mobile station.

18. The mobility-management unit of claim 17, wherein the protocol-analysis unit is configured to evaluate information about a signaling-protocol revision level contained in the at least one Mobile-Station-Classmark information element.

19. The mobility-management unit of claim 14, wherein the protocol-analysis unit is configured to evaluate information about a revision level contained in at least one Radio-Access-Capability information element received from the mobile station.

20. The mobility-management unit of claim 14, wherein the protocol-analysis unit is configured to ascertain whether the mobile station supports a specific signaling-protocol feature.

21. The mobility-management unit of claim 14, wherein the rejection-management unit further comprises a rejection controller, which is connected with the protocol-analysis unit and configured to select a rejecting mobility-management response message in dependence on the protocol-compliance signal and provide at its output a rejection-control signal indicative of the selected rejecting mobility-management response message to be sent to the mobile station.

22. The mobility-management unit of claim 21, wherein the rejection controller is configured to select a rejecting mobility-management response message that contains control information triggering the mobile station to select a different public land mobile network for service.

23. The mobility-management unit of claim 21, comprising a roaming controller, which is configured to ascertain an alternative public land mobile network in dependence on the first reject cause information element, and to select a rejecting mobility-management response message that contains control information instructing the mobile station to request service from the alternative public land mobile network.

24. The mobility-management unit of claim 21, wherein the rejection controller is configured to select a mobility-management response message that contains control information triggering the mobile station to abandon the mobility-management request without selecting a different public land mobile network for service.

25. The mobility-management unit of claim 21, wherein the rejection controller is configured to select a mobility-management response message containing a second reject-cause information element, which is different from the first reject-cause element and known to the mobile station.

26. A software module for implementation of a mobility-management unit in a network node of a public land mobile network, comprising a rejection-management sub-module, which is configured to
ascertain whether a mobility-management request received from a mobile station is to be rejected,
if the mobility-management request is to be rejected, ascertain a suitable first reject-cause information element indicating the reason for rejection,
ascertain whether the first reject-cause information element is known to the mobile station,
if the reject-cause information element is not known to the mobile station, generate a mobility-management response to be sent to the mobile station and suitable to prevent a re-transmission of the mobility-management request by the mobile station.

27. A software module which is configured to implement a rejection-management unit as set forth in claim 14.

28. A network node for operation in a public land mobile network, comprising a mobility-management unit according to claim 13.

29. The software module of claim 27, wherein the network node is configured to operate as a Mobile Switching Center.

30. The software module of claim 27, wherein the network node is configured to operate as a Serving GPRS Support Node.

31. A public land mobile network, comprising a network node including a software module according to claim 27.
